(19) United States
(12) Patent Application Publication
(10) Pub. No.: US 2007/0015021 A1
(43) Pub. Date: Jan. 18, 2007

(54) Canless bi-cell

(76) Inventors: Yaron Shrim, Mevasseret (IL); Ronald Alan Putt, Auburn, AL (US); Jacob Rosenberg, Jerusalem (IL); Victor Bogdanovsky, Jerusalem (IL); Alexander Gutkin, Rehovot (IL); Neal Naimer, Shikmim (IL)

Correspondence Address: Stephan A. Pendorf;Pendorf & Cutliff, 5111 Memorial Highway, Tampa, FL, 33634-7356, US

(21) Appl. No.: 11/183,506

(22) Filed: Jul. 18, 2005

(51) Int. Cl. H01M 12/06; H01M 4/86; H01M 2/08

(52) U.S. Cl. 429/27; 429/40; 429/35

(57) ABSTRACT

The invention provides a substantially flat, planar, metal-air canless bi-cell having two major surfaces formed of oppositely-disposed spaced-apart gas-permeable liquid-impermeable air-electrode cathodic material, defining therebetween a space containing a fluid anodic material comprising anodic metal particles and electrolyte.

### BACKGROUND OF THE INVENTION

1. Field of the Invention

The present invention relates to electrochemical cells. More particularly, the invention provides a planar, metal-air canless bi-cell and a battery containing a multitude of said cells. The word “can” in the context of electrochemical cells is a recognized term in the art and the term “canless” as used herein refers to a cell using its active components as an outer casing.

2. Related Art of the Invention

The important desired properties of electrochemical cells are high energy and power per cell weight, and per cell volume, a flat discharge curve, and reasonable shelf life. Energy density, per weight or per volume of a defined cell is not a fixed value, as much depends on the rate of discharge being near the design discharge. For example, a cell of the type used in a wristwatch is required to supply a very low current over a period of about 5 years, while a cell used in a torpedo needs to supply a high current for a few minutes only. Furthermore, some cells operate best, or only at all at temperatures far removed from room temperature, and also there are applications where cost is, or is not an important consideration. To accommodate such varied requirements, many different types of primary and secondary batteries apart from the original lead-acid have been developed, for example the nickel-cadmium, silver zinc, zinc-nickel zinc-oxygen and zinc air, the latter being the subject of the present invention.

Battery cells are usually supplied with an outer casing which takes no part in chemical reactions taking place. The casing does however add both weight and volume, which is an important consideration in vehicles, particularly in aerospace applications. An important application for batteries of the type relating to the present invention is for powering unmanned aerial vehicles and running auxiliary equipment, such as cameras, navigation instruments, radio controls etc. of unmanned aerial vehicles (drones.)

### SUMMARY OF THE INVENTION

The present inventors have previously disclosed new designs of zinc-anode cells.

In U.S. Pat. No. 5,366,822 we disclosed a zinc-air cell of a type which is suitable for use in an electrically-propelled road vehicle. The improvements detailed include improved air flow across the air electrodes, loss-free electric terminals and arrangements for rapid exchange of exhausted anodes.

Further, in U.S. Pat. No. 5,445,901 we disclosed a Zinc-oxygen battery which is also intended for vehicular use, particularly sea-craft, and is sufficiently compact for use in torpedoes. The primary improvement of this patent was the addition of thin plastic sheets or films between adjacent cathodes. One of the functions of said sheets was to divert water droplets formed by condensation away from the cell and into dead space of the battery casing.

While the designs described in the above-mentioned patents were satisfactory for their intended use, the acute demand for weight reduction, and to a lesser extent also volume reduction posed by aerospace applications are difficult to satisfy with the cells referred to which are provided with a frame.

It is therefore one of the objects of the present invention to obviate the disadvantages of prior art zinc-air cells and to provide a thin, flat, canless cell having high W-hr/kg and W-hr/dm³ ratios, typically both ratios being above 150 as measured when used in a practical battery.

It is a further object of the present invention to provide a thin, flat, canless zinc-air cell having high W/kg and W/dm³ ratios, typically both ratios being above 100 as measured over a continuous discharge in a practical battery.

It is a further object of the present invention to provide a compact cell suitable for use in unmanned aerial vehicles.

The present invention achieves the above objects by providing a substantially flat, planar, metal-air canless bi-cell having two major surfaces formed of oppositely-disposed spaced-apart gas-permeable liquid-impermeable air-electrode cathodic material, defining therebetween a space containing a fluid anodic material comprising anodic metal particles and electrolyte.

In a preferred embodiment of the present invention there is provided a planar metal-air canless bi-cell wherein said two major surfaces are formed of a single air-electrode cathodic material folded upon itself.

In a most preferred embodiment of the present invention there is provided a planar metal-air canless bi-cell having a thickness of about 2 to 15 mm and a length and a width exceeding said thickness.

Also, the invention includes a battery formed from a plurality of planar metal-air canless bi-cells as described.

Yet further embodiments of the invention will be described hereinafter.

It will thus be realized that the novel bi-cell of the present invention in its thinner embodiment can be bent, formed or shaped to satisfy the space restrictions met in unmanned vehicles, such as drones and torpedoes.

In preferred embodiments of the present invention, said fluid anodic material is a pumpable material which is added after the formation of the electrochemical cell just before the sealing thereof.

In other preferred embodiments, the anodic metal particles can be first introduced after which the electrolyte, usually dilute aqueous KOH, is added in the factory, or added immediately prior to use.

With regard to a battery comprising such cells, the cells will be interconnected through their terminals in a manner similar to other batteries. The series-parallel connection is arranged according to the voltage and current which the battery is intended to deliver.

As will be realized, the present invention also is directed to the technology of sealing a prismatic primary metal air bi-cell. The seal of a prismatic cell is by far more complicated than the seal of a rounded cell in that in a round cell, the seal is carried out in one plane and can be achieved by application of central forces while heretofore, in a prismatic cell, the seal has to be on each edge of the cell, and has to overcome the discontinuity of the seal in the cell corners.

The present invention obviates this problem by providing a sealed cell without the use of any metal cans. Thus, the parasitic weight of the assembled cell is substantially reduced.

The present seal design also allows the building of a cell having a footprint which is very high compared to its thickness, where in cell length and width are at least twice the cell thickness, and theoretically has no upper limit and thus allows the cell to deliver high power.

Furthermore, the seal design allows the building of a cell without any footprint geometry to fit any application geometry.

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

In the drawings:

FIG. 1 is a cross-sectional view of a first preferred embodiment of a bi-cell according to the present invention;

FIG. 2 is a perspective view of an internal anode-confining frame member adapted to be inserted between the air-electrode cathodic material of preferred bi-cells of the present invention;

FIG. 3 is a perspective view of a second preferred embodiment of a bi-cell according to the present invention;

FIG. 4 is a perspective view of a thin frame member adapted to wrap the air electrode edges and the internal plastic frame to assure cell seal and prevent internal shorts to form the preferred bi-cell of FIG. 1;

FIG. 5 is a cross-sectional view of the thin frame member of FIG. 4;

FIG. 6 is an enlarged cross-sectional view of a portion of a further preferred embodiment of a bi-cell according to the present invention;

FIG. 7 is a perspective view of a preferred anodic current collector for use in the bi-cell of the present invention;

FIG. 8 is a further enlarged cross-sectional view of a portion of the end of the bi-cell shown in FIG. 6 with a sealing plug inserted therein;

FIG. 9 is an enlarged cross-sectional view of the anode feed through; and

FIG. 10 is an enlarged cross-sectional view of the cathode feedthrough.

### DETAILED DESCRIPTION OF THE INVENTION

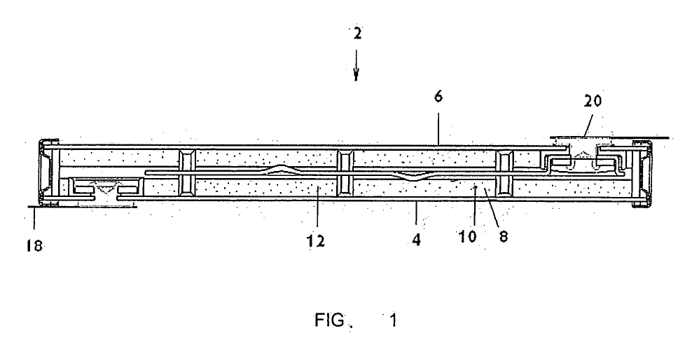

There is seen in FIG. 1 a first preferred embodiment of a substantially flat, planar, metal-air canless bi-cell 2 having two major surfaces 4 and 6 formed of oppositely disposed spaced apart gas-permeable liquid-impermeable air-electrode cathodic material defining therebetween a space 8 containing a fluid anodic material 10 comprising anodic metal particles 12 and electrolyte wherein said electrolyte comprises an ionic material such as KOH and said anodic metal particles 12 are preferably zinc.

The cathodic material is typically composed of a catalyzed carbon and a metallic current collector. The cathodic material is preferably covered externally by a gas permeable hydrophobic film such as Teflon, and internally by a separator such as a non-conductive ion-permeable film (not shown).

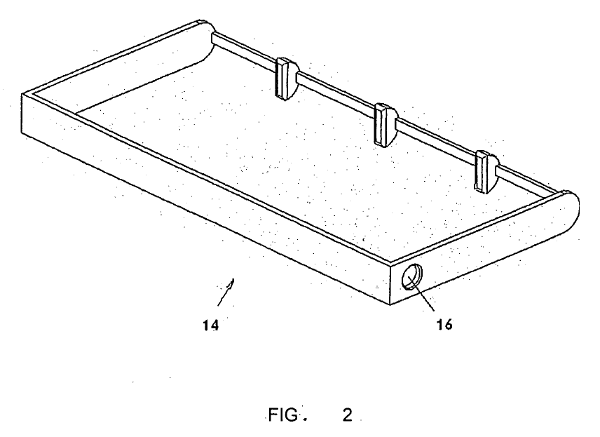

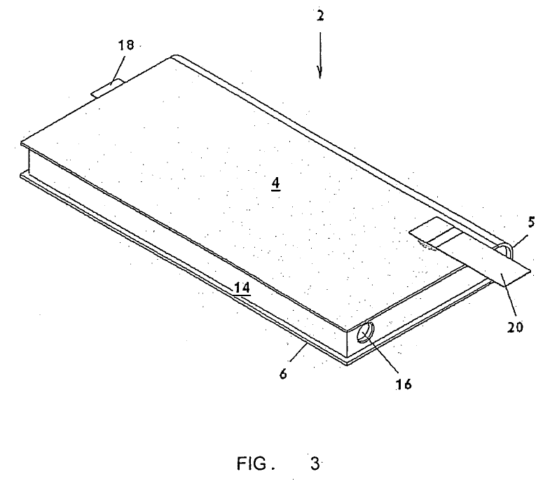

Referring to FIG. 2 (and to FIG. 1 with regard to features not seen in FIG. 2), there is seen an internal frame member 14 preferably made of thin walled plastic material and adapted in conjunction with surfaces 4 and 6 of the cathodic material and canister web 5 thereof (shown in FIG. 3) to retain the fluid anodic material 10. Frame member 14 is provided with an opening 16 for filling the fluid anodic material 10 which is preferably in gel form into the canless bi-cell 2 after the sealing of surfaces 4 and 6 around frame member 14.

Any joining method that is resistant to a mild alkali may be used.

In reference to the following Figures, similar number will be used to designate similar features referred to in the previous Figures.

Referring to FIG. 3, there is seen a perspective view of a further preferred embodiment the formed canless bi-cell 2 having major surfaces 4 and 6 formed of oppositely disposed, spaced-apart gas-permeable, liquid-impermeable, air-electrode cathodic material and sealed around frame member 14. Also seen are cathode tab 18 and anode tab 20. As will be noted, in this preferred embodiment said two major surfaces 4 and 6 are formed of a single air-electrode cathodic material folded upon itself around internal plastic frame member 14 into a substantially u-shape with surfaces 4 and 6 being connected by web 5.

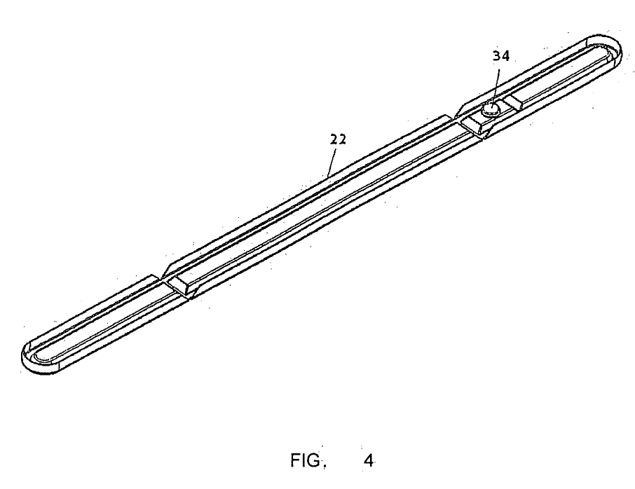

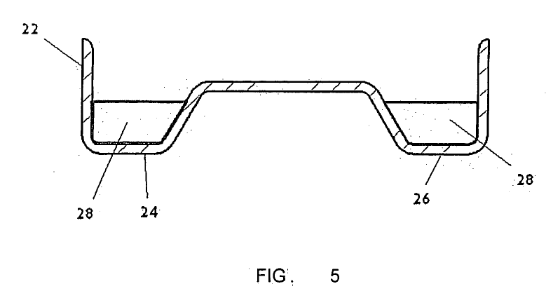

Referring to FIGS. 4 and 5 there are respectively seen a perspective and cross-sectional view of a preferred thin frame member 22 configured to wrap around the edges of surfaces 4 and 6 of the cathodic material and to seal the same together with the internal frame member 14 to assure cell seal and prevent internal shorts and to form the preferred embodiment seen in FIG. 1. Channels 24 and 26 of thin frame member 22 are shown (in FIG. 5) as being primed with a glue 28 to facilitate the sealing thereof to surfaces 4 and 6. Said thin frame member 22 is preferably a thin vacuum forming plastic foil or a porous foil. As will be realized, glue 28 enables the bonding of the thin vacuum formed frame member 22, the edges of cathodic surfaces 4 and 6 and the internal thin walled plastic frame member 14. Frame member 22 is provided with an opening 34 adapted to align with opening 16 of internal frame member 14 for introducing the liquid anodic material 10 into the cell after the assembly thereof. In preferred embodiments of the present invention said liquid anodic material 10 is in the form of a gel.

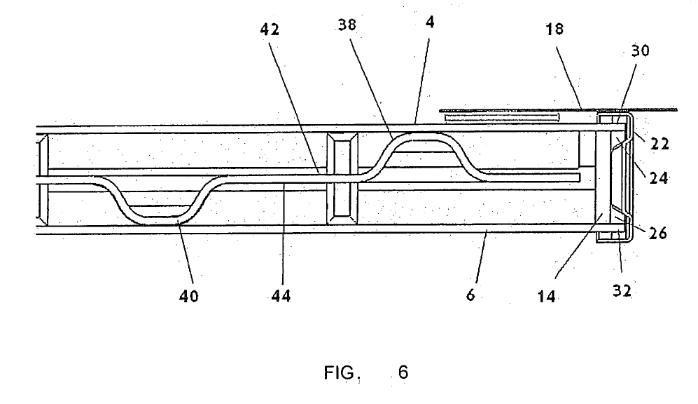

Referring to FIG. 6 in which similar numbers have been used to refer to similar parts as referred to in the previous drawings, it is seen that cathodic surfaces 4 and 6 are preferably provided with protruding edges 30 and 32 respectively designed to protrude into the glue filled channels 24 and 26 of thin frame member 22 when the same is sealed to internal frame member 14. Protruding edges 30 and 32 of the cathodic material can also be coated with glue (not shown) before assembling in order to obtain a better seal with internal frame member 14 and external frame member 22 and to prevent the possibility of an internal short, by gluing the separator (not shown) to the internal frame 14.

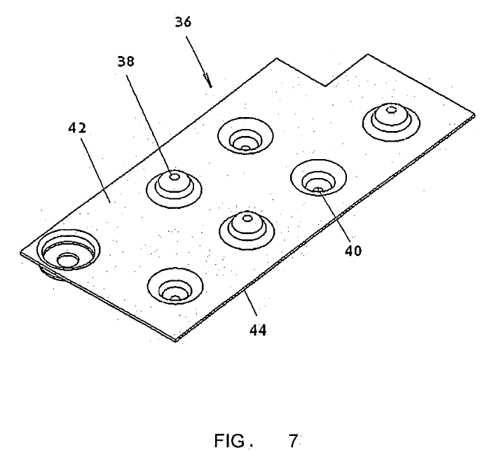

Referring to FIG. 7 there is seen an anodic current collector 36 which is preferably made of tin plated copper, which could either be mesh or expanded metal and which can be shaped and/or stamped to produce protruding surfaces 38 and 40 extending equidistant from the top surface 42 and the bottom surface 44 of said current collector in such a way as to assure that it will be placed and positioned in the center of the formed cell as seen with reference to FIG. 6 in order to allow easy flow and equal fill of the anodic liquid, preferably gel, on each side of the anodic current collector.

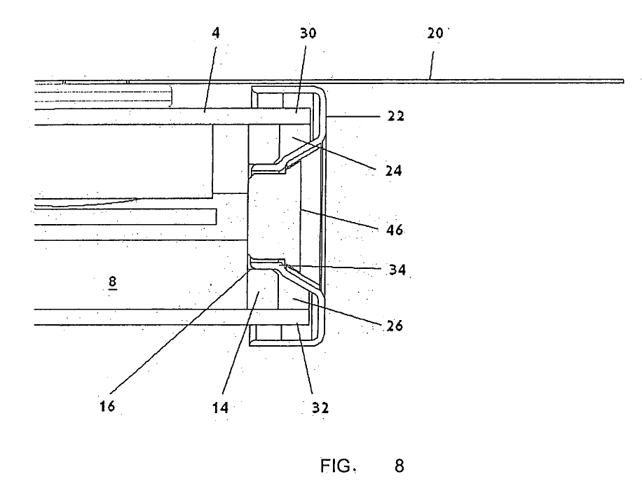

Referring to FIG. 8 it will now be more clearly seen that frame member 14 is provided with an anode filling opening 16 and frame member 22 is provided with an opening 34 aligned with opening 16 of internal frame member 14 for introducing the liquid anodic material 10 into the cell after the assembly thereof. Once the liquid anodic material has been introduced into the cell both of said openings are sealed by plug member 46.

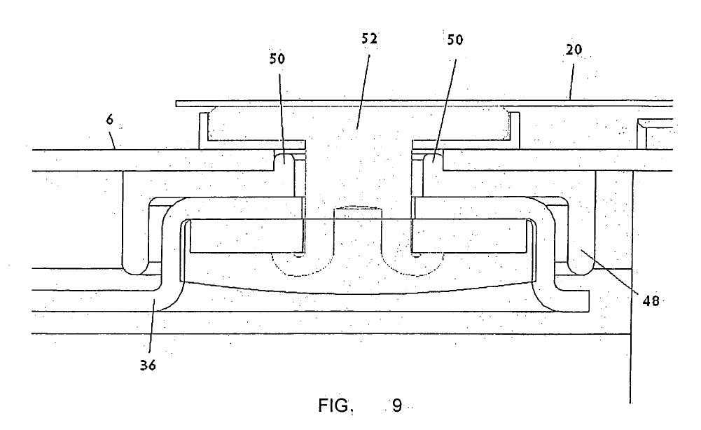

Referring to FIG. 9 there is seen a preferred arrangement of the anode feed through passing through the surface 6 of the air-electrode cathodic material. In order to prevent a short circuit, a plastic cup-like element 48 with a rib-like end 50 is positioned between rivet 52 and the surface 6 of the air-electrode cathodic material, said rivet being electrically connected to anode tab 20.

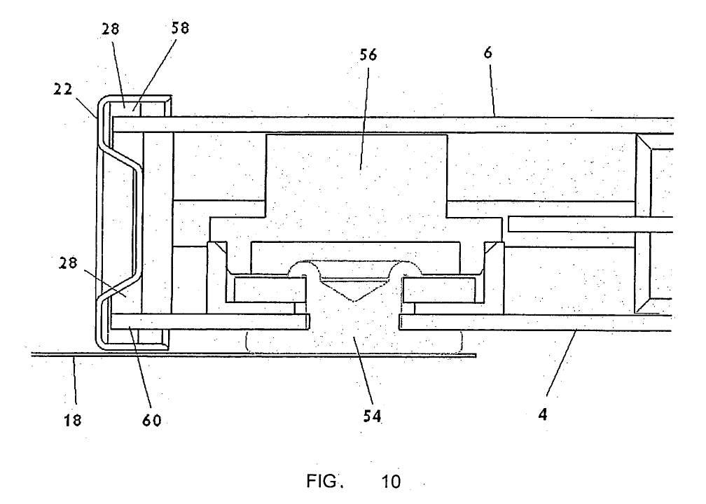

Referring to FIG. 10 there is seen cathode tab 18 which is electrically connected and preferably spot welded to rivet 54 which rivet is preferably supported in place by support plug 56 to allow the carrying out of said spot welding without deforming the air electrode. As will be noted air-electrode cathodic surfaces 4 and 6 are provided also on the cathode tab 18 side of the cell with protrusions 58 and 60 similar to protrusions 30 and 32 referred to in FIG. 6 and providing the same function.

The components discussed above can be made of any suitable material known per se in the art and the rivets are preferably made of stainless steel while the plastic cup-like element 48, the support plug 56, the internal frame 14, and plug member 46 are all preferably made of a plastic such as Plastic Noryl®.

As is known per se in the art oxygen reaches the active area of the cell by either diffusion or forced means e.g. a fan or RAM air of a moving vehicle.

The finished cell 2 has a thickness usually in the range of 2-15 mm. The length and width of the cell, which determine the cell W-hr capacity and W power, exceed the thickness thereof, typically by at least a factor of 3.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A substantially flat, planar, metal-air canless bi-cell having two major surfaces formed of oppositely-disposed spaced-apart gas-permeable liquid-impermeable air-electrode cathodic material, defining therebetween a space containing a fluid anodic material comprising anodic metal particles and electrolyte.

2. The planar metal-air canless bi-cell according to claim 1, comprising a pair of oppositely-disposed spaced-apart gas-permeable liquid-impermeable air-electrode cathodes being joined along edges thereof to an internal anode confining frame member.

3. The planar metal-air canless bi-cell according to claim 1, wherein said two major surfaces are formed of a single air-electrode cathodic material folded upon itself.

4. The planar metal-air canless bi-cell according to claim 1, having a thickness of about 2 to 15 mm and a length and a width exceeding said thickness.

5. The planar metal-air canless bi-cell according to claim 2, wherein said cathodic material is joined to said frame member by sealing material along edges thereof.

6. The planar metal-air canless bi-cell according to claim 5, wherein said sealing material is electrically insulating.

7. The planar metal-air canless bi-cell according to claim 5, wherein said sealing material is selected from the group consisting of an adhesive, a polymer and rubber.

8. The planar metal-air canless bi-cell according to claim 1, wherein said anode is electrically connected to a negative terminal via an electrically conductive means that passes through an edge seal thereof.

9. The planar metal-air canless bi-cell according to claim 1, wherein said anode is electrically connected to a negative terminal via an electrically conductive means that passes through one of said major surfaces and is electrically insulated therefrom.

10. The planar metal-air canless bi-cell according to claim 1, wherein the active material of said anode is an electropositive metal.

11. The planar metal-air canless bi-cell according to claim 1, wherein said fluid anodic material is premixed and in pumpable form.

12. The planar metal-air canless bi-cell according to claim 1 wherein said fluid anodic material is premixed and in pumpable gel form.

13. The planar metal-air canless bi-cell according to claim 1, wherein said active material of said anode is selected from the group consisting of electrolytically-formed particles, thermally produced battery powder, fibers, foils, sheets, expanded mesh and combinations thereof.

14. The planar metal-air canless bi-cell according to claim 1, wherein said anode is produced by a process selected from the group consisting of pressing, pasting and sintering active anodic material.

15. The planar metal-air canless bi-cell according to claim 1, wherein said cathodic material is electrically connected to a positive terminal via a joining means.

14. The planar metal-air canless bi-cell according to claim 1, wherein said positive terminal of said bi-cell is formed by extending at least a portion of said cathodic material via an edge seal of said bi-cell.

15. A battery formed from a plurality of planar metal-air canless bi-cells having two major surfaces formed of oppositely-disposed spaced-apart gas-permeable liquid-impermeable air-electrode cathodic material, defining therebetween a space containing a fluid anodic material comprising anodic metal particles and electrolyte.
